(19) United States
(12) Patent Application Publication
(10) Pub. No.: US 2026/0175880 A1
(43) Pub. Date: Jun. 25, 2026

(54) GANGWAY FOR PROVIDING A TRANSITION BETWEEN A FIRST VEHICLE PART AND A SECOND VEHICLE PART OF A VEHICLE, AND VEHICLE WITH SUCH A GANGWAY

(71) Applicant: HÜBNER GmbH & Co. KG, Kassel (DE)

(72) Inventor: Michael Krug, Niedenstein (DE)

(73) Assignee: HÜBNER GmbH & Co. KG, Kassel (DE)

(21) Appl. No.: 18/990,870

(22) Filed: Dec. 20, 2024

(30) Foreign Application Priority Data
Dec. 1, 2023 (EP) 23213686.1

(51) Int. Cl. B61D 17/20

(52) U.S. Cl. CPC B61D 17/20

(57) ABSTRACT

A gangway is providing a transition between a first vehicle part and a second vehicle part of a vehicle. The first vehicle part has a first wagon-end face and the second vehicle part has a second wagon-end face. The gangway has at least one centering element with a first and second end, at least one first base plate, at least one second base plate, and at least one tread plate which are movably connected to the centering element in a plate plane. A rotation axis is fastened to the first wagon-end face or interacts with the first wagon-end face and runs within the plate plane or parallel to the plate plane. For the rotatable connection of the centering element to the first wagon-end face, the rotation axis passes through the centering element at the first end. A vehicle may have such a gangway.

### CROSS-REFERENCE TO RELATED APPLICATION

This application claims priority to European Patent Application No. 23213686.1, filed December 1, 2023, the contents of which are incorporated herein by reference in its entirety.

### FIELD OF THE INVENTION

The present invention relates to a gangway for providing a transition between a first vehicle part and a second vehicle part of a vehicle. Furthermore, the present invention relates to a vehicle with such a gangway.

### BACKGROUND OF THE INVENTION

Such gangways can be designed in the manner of a combination bridge, also called a “combi bridge” for short, and serve to provide a safe transition for passengers, in particular of a rail vehicle or a bus, between two adjacent vehicle parts. The gangways have a centering element on which a first base plate, a second base plate, and a tread plate are usually movably mounted in order to compensate for the relative movements between the first vehicle part and the second vehicle part arising during operation of the vehicle. The first base plate is connected to the first part of the vehicle and the second base plate to the second part of the vehicle, while the tread plate is arranged between the two base plates and overlaps them slightly. Further information on such gangways can be found in EP 0331121 A2, EP 0669243 A1, EP 0958981 A1, and EP 0722873 A1.

On long-distance trains, the gangways are mainly crossed by passengers in order to get from one part of the vehicle to the adjacent part. The stay time of the passengers is correspondingly short. However, especially on underground railways and metros, a large number of passengers stay in the gangways, in particular at peak times. The load on the gangways is correspondingly high, and the gangways must be accordingly dimensioned which, among other things, increases the weight.

In many cases, the gangways are surrounded by bellows to enable a continuously closed transition between two adjacent vehicle parts. Electrical cables and other supply lines, e.g., for air conditioning, often run in the bellows. In addition, the vehicle parts are connected to each other with coupling devices. The aforementioned components often run beneath the gangways. For maintenance purposes, it is therefore desirable to be able to remove the gangways quickly and easily in order to provide access to the mentioned components. The combination bridge disclosed in EP 2457796 A1 is basically suitable for use in underground railways and metros, but the dismantling effort in the event of maintenance is relatively high. EP 2 700 553 A1 proposes a gangway which can be pivoted about a rotation axis. In the event of maintenance, it can be rotated around the rotation axis with relatively little effort, whereby access can be provided to the elements arranged below the gangway in relation to the intended arrangement. The rotation axis runs between the vehicle part and the base plate, whereby the flow of force through the centering element also leads through the base plate and only then into the vehicle part. The same is also the case with the combination bridge disclosed in EP 4035911 A1. The load-bearing capacity of these gangways is limited, in particular due to the flow of force through the relatively thin base plate, which is why they are only partially suitable for use in underground railways and metros.

### SUMMARY OF THE INVENTION

The object of one embodiment of the present invention is to propose a gangway for a transition or of a transition between a first vehicle part and a second vehicle part of a vehicle, with which it is possible to provide a remedy for the aforementioned disadvantages. In particular, the gangway shall, on the one hand, enable quick and easy access to be provided to components arranged between two adjacent vehicle parts and, on the other, also be usable for high loads such as those occurring in underground railways and metros. Furthermore, one embodiment of the present invention is based upon the object of creating a vehicle which can be equipped with such a gangway.

This object is achieved with the features disclosed herein. Advantageous embodiments are also disclosed.

One embodiment of the invention relates to a gangway for a transition or of a transition between a first vehicle part and a second vehicle part of a vehicle, wherein

the first vehicle part has a first wagon-end face, and the second vehicle part has a second wagon-end face, and the gangway comprises:

at least one centering element with a first end and a second end,

at least one first base plate, at least one second base plate, and at least one tread plate which are movably connected to the centering element in a plate plane, and

a rotation axis attached to the first wagon-end face or interacting with the first wagon-end face and running within the plate plane or parallel to the plate plane,

wherein, for the rotatable connection of the centering element to the first wagon-end face, the rotation axis passes through the centering element at the first end or in the region of the first end.

In this gangway, the first base plate, the second base plate, and the tread plate are connected to the centering element. The centering element can be designed as a scissor frame. However, the first base plate is not directly connected to the first wagon-end face. Rather, the centering element is directly connected to the first wagon-end face so as to rotate about the rotation axis. This can be achieved, for example, by attaching a projection with an opening to the first wagon-end face, wherein the rotation axis passes through the opening. The centering element is connected to the rotation axis at the first end or in the region of the first end in such a way that the centering element is rotatable about the rotation axis. Although the centering element can comprise components to provide the rotatable connection of the centering element to the rotation axis, these components generally do not have any functions beyond this. In particular, the building elements are not base plates or the like. The rotation axis can be formed, for example, by a rod or a bolt.

The force flow therefore runs directly between the first wagon-end face and the centering element, which is why the present gangway is suitable for high loads. In particular, the first base plate, which is to be understood as the proximal base plate viewed from the first wagon-end face, is not directly connected to the first wagon-end face, but, as explained, only indirectly to the centering element, and is therefore not part of the force flow. This means that, in contrast to the combination bridge shown in EP 2457796 A1, the rotation takes place only around a common rotation axis so that, during rotation, there is no relative movement between the first base plate, the second base plate, as well as the tread plate and the centering element. Accordingly, in the combination bridge disclosed in EP 2457796 A1, the first base plate, the second base plate, the tread plate, and the centering element can be rotated only by a maximum of 20°, so that no usable access can be provided to the components arranged between two adjacently arranged vehicle parts. In contrast, the combination bridge according to the invention allows, in principle, unlimited rotation.

The features “first end” and “second end” can be interpreted broadly, so that, for example, the rotation axis could also pass through the centering element a little further towards the center thereof.

According to a further embodiment, the gangway can have a locking device with which the centering element at its second end and/or the second base plate can be detachably connected to the second wagon-end face. The locking device can ensure that no excessively large gap is formed between the second base plate and the second wagon-end face that could pose a danger to the passengers of the vehicle in question. The size of the gap can be defined by the locking device in such a way that relative movements which occur during operation of the vehicle between the first vehicle part and the second vehicle part are permitted, without significant friction and the abrasion associated therewith. In addition, any developing noise that can arise thereby can be avoided.

In a further developed embodiment,

a first end strip can be arranged on the first wagon-end face, and/or

a second end strip can be arranged on the second wagon-end face, wherein

the first axis of rotation can be fastened to the first end strip, and/or the locking device can interact with the second end strip for releasably fastening the centering element.

In many cases, the first vehicle part and the second vehicle part are manufactured by different manufacturers than the gangway. Consequently, the first wagon-end face and the second wagon-end face often cannot be adapted to the structural details of the gangway. In contrast, the first end strip and the second end strip can be designed by the manufacturer of the gangway in a way that seems reasonable for the function and operation of the gangway. The first end strip and the second end strip can be adapted to the structural conditions of the respective first wagon-end face and second wagon-end face with comparatively little effort. In this respect, the first end strip and the second end strip act as a kind of adapter between the gangway and the first vehicle part and the second vehicle part. Even retrofitting vehicles that have already been in operation for a long time is possible with little effort using the end strips. However, it should be pointed out at this juncture that it is entirely possible to fasten the first rotation axis to the first wagon-end face and/or to design the locking device in such a way that it can cooperate with the second wagon-end face for releasably fastening the centering element.

At this juncture, it should be pointed out that, in this embodiment, the rotation axis is, strictly speaking, no longer attached to the first wagon-end face, but to the first end strip. However, the first end strip can be attached to the first wagon-end face in such a way that the force flow continues to be largely direct from the centering element into the first wagon-end face, without the first base plate or other structural elements being involved in the force flow. At least in this embodiment, the centering element interacts with the wagon-end face using the first end strip.

In a further developed embodiment, the second wagon-end face and/or the second end strip can have fastening sections into which counter-fastening sections of the gangway and in particular the second base plate and/or the centering element can be introduced. The fastening sections and the counter-fastening sections can be part of the locking device, which can be easily adapted to the structural conditions of the first vehicle part and the second vehicle part.

According to a further embodiment, the counter-fastening sections are rotatably mounted on the gangway and in particular on the second base plate. As mentioned, the counter-fastening sections interact either with the second wagon-end face and/or with the second wagon-end face, and in any case with the second vehicle part, while the gangway as such is mounted on the first vehicle part. In particular, if the two vehicle parts pitch relative to each other, the rotational position of the counter-fastening sections relative to the second wagon-end face, to the second end strip, and/or to the fastening sections would also change, as a result of which the counter-fastening sections could be exposed to increased loads or could move out of the fastening sections. Due to the rotatable mounting of the counter-fastening sections, these can follow the rotational movements of the first vehicle part and the second vehicle part relative to each other, whereby the above-mentioned increased loads and the movement out of the fastening sections can be avoided. The rotatable mounting of the counter-fastening sections can be realized, for example, by means of a bearing axis which is fastened to the second base plate.

In a further embodiment, the centering element or the gangway can be movable between

a first rotational position in which the centering element and/or the second base plate can be connected or is connected to the second wagon-end face, and

a second rotational position, wherein

holding means for fixing the centering element or the gangway in the second rotational position are arranged on the first wagon-end face.

In the first rotational position, the centering element, in particular together with the first base plate, the second base plate, and the tread plate, provides the transition between the first vehicle part and the second vehicle part. To move the centering element from the first rotational position to the second rotational position, the centering element is rotated by approximately 90°. In the second rotational position, access is possible to components of the vehicle that are arranged below the gangway, in particular to the coupling device, in particular for inspection and maintenance purposes. In the second rotational position, the connection of the centering element and/or the second base plate to the second wagon-end face is removed, whereby the first vehicle part can be separated from the second vehicle part. In order to prevent the centering element together with the first base plate, the second base plate, and the tread plate from being able to leave the second rotational position in an uncontrolled manner, the gangway in this embodiment has holding means. The holding means can be arranged on the first wagon-end face and, in the second rotational position, interact in particular with the first base plate, the second base plate, and/or the tread plate. Due to the connection of the first base plate, the second base plate, and the tread plate to the centering element, this is also fixed in the second rotational position. In this respect, the centering element interacts at least indirectly with the holding means. A direct connection between the holding means and the centering element would also be conceivable. It is crucial that the gangway be able to be fixed in the second rotational position with the holding devices. The first rotational position can be determined, for example, by means of an alignment element which is fastened to the second base plate and rests, for example, on a projection of the second wagon-end face or the second end strip.

A further developed embodiment can be characterized in that the gangway has

a first centering element having a primary first end and a primary second end, and a second centering element having a secondary first end and a secondary second end, and/or

a primary first base plate, a primary second base plate, and a first tread plate which are movably connected to the first centering element in the plate plane, and/or

a secondary first base plate, a secondary second base plate, and a second tread plate which are movably connected to the second centering element in the plate plane, and/or

a first rotation axis which is fastened to the first wagon-end face or second wagon-end face and runs within the plate plane or parallel to the plate plane and which passes through the first centering element at the primary first end or at the primary second end in order to connect the first centering element to the first wagon-end face or to the second wagon-end face, and/or

a second rotation axis which is fastened to the first wagon-end face or second wagon-end face and runs within the plate plane or parallel to the plate plane and which passes through the second centering element at the secondary first end or at the primary second end in order to connect the secondary centering element to the first wagon-end face or to the second wagon-end face.

In this embodiment, the gangway is divided in two and has a first subunit with a first centering element, a primary first base plate, a first tread plate, and a primary second base plate. In addition, the gangway has a second subunit with a second centering element, a secondary first base plate, a second tread plate, and a secondary second base plate. While the first subunit is rotatably attached to the first wagon-end face with the first centering element, the second subunit is rotatably attached to the second wagon-end face with the second centering element. The parting plane between the first subunit and the second subunit, at which the base plates and the tread plates abut each other, runs parallel to the main direction of travel of the vehicle and, when the vehicle is traveling straight ahead or is oriented in a straight line, perpendicular to the first wagon-end face and the second wagon-end face.

The first subunit and the second subunit can be constructed identically or almost identically, which is advantageous from a manufacturing point of view. In contrast to a one-piece design, the subunits are shorter and lighter, which makes assembly and transport easier, especially to the assembly site. In particular due to the lower weight, the first subunit and the second subunit can be moved between the first rotational position and the second rotational position with less exertion of force. In addition, for maintenance and inspection purposes, it can be sufficient to move only one of the subunits to the second rotational position. The transition between the first vehicle part and the second vehicle part is still possible with the other subunit, albeit with restrictions. This keeps disruptions during maintenance or inspection to a minimum.

Both the first subunit and the second subunit can be rotatably connected to a common rotation axis, wherein the common rotation axis can be arranged on the first wagon-end face or the second wagon-end face. However, if the first subunit and the second subunit are to be constructed identically or largely identically, it is advisable to arrange the first subunit on the first wagon-end face and the second subunit on the second wagon-end face, or vice versa. In this case, each of the subunits has its own rotation axis to which they are rotatably connected.

The tread plate parting plane between the first tread plate and the second tread plate can be offset from the base plate parting planes between the primary first base plate and the secondary second base plate, or between the primary second base plate and the secondary first base plate. This creates overlapping areas between the first subunit and the second subunit so that loads can be transferred between the first subunit and the second subunit. The first subunit and the second subunit are therefore loaded more evenly than if the tread plate parting plane and the base plate parting planes were aligned with each other.

The number of subunits is not limited to two, and can in principle be chosen arbitrarily. Three or four subunits might be advantageous in some applications.

According to a further embodiment,

the gangway has a first locking device with which the first centering element at its primary second end or the primary second base plate can be connected to the first wagon-end face or the second wagon-end face, and/or

the gangway has a second locking device with which the second centering element at its secondary second end or the secondary second base plate can be connected to the first wagon-end face or the second wagon-end face.

The first locking device and the second locking device can ensure that no excessively large gap is formed between the primary second base plate and the second wagon-end face or the secondary second base plate and the first wagon-end face that could pose a danger to the passengers of the vehicle in question. The size of the gap can be defined by the first locking device or the second locking device such that relative movements which occur during operation of the vehicle between the first vehicle part and the second vehicle part are permitted without significant friction and the abrasion associated therewith. In addition, any developing noise that can arise thereby can be avoided.

In a further embodiment, it can be appropriate for the gangway to comprise a connecting body or a connecting structure with which the first tread plate and the second tread plate can be connected to one another in a force-transmitting and detachable manner. The connection structure can, for example, be designed in the form of a tongue-and-groove connection. A connecting body can, for example, be a rod arranged on the first tread plate, which can engage in a complementary recess in the second tread plate. In this way, loads can be transferred between the two subunits so that they are loaded more evenly overall. In addition, it can be prevented that one subunit deform significantly under a particularly high load, while the other subunit deform less due to a lower load. Steps over which passengers could trip are avoided due to the varying degrees of deformation.

In this embodiment, it is provided that the connecting body interact with the first tread plate and the second tread plate. However, this does not exclude alternatively or cumulatively providing connecting bodies which interact with the base plates to transmit force. The technical effects thereby achieved are basically the same as those provided by a connecting body that interacts with the tread plates.

According to a further embodiment, the connecting body can have projections and/or recesses with which the first tread plate and the second tread plate can be brought into engagement in a form-fit by means of a movement along the plate plane. For this purpose, the connecting body can, for example, have an H-shaped cross-section. For example, the first tread plate can be inserted into one of the recesses and then screwed to the connecting body. The second tread plate can be inserted into the second recess by means of a movement along the plate plane when the first subunit and the second subunit are in the first rotational position. If the second tread plate is to be placed in the second rotational position, the second tread plate is first moved out of the second recess and then placed in the second rotational position.

Alternatively, for example, the connecting body can have one or more locking hooks that engage in locking sections of the second tread plate. In addition to locking, the locking hooks also serve to transfer forces and moments between the subunits.

In a further developed embodiment, the connecting body can have

a first subsection connected to the first tread plate and

a second subsection connected to the second tread plate.

In this embodiment, the connecting body is divided in two. This makes it possible to design the first subsection and the second subsection of the gangway identically or largely identically, which is advantageous in terms of manufacturing and simplifies assembly.

According to a further embodiment, the gangway can have a fixing device with which the first tread plate and the second tread plate can be detachably connected to one another in such a way that the position of the first tread plate can be fixed relative to the second tread plate. As mentioned above, the first centering element and the second centering element are designed in such a way that they allow movement of the base plates and the tread plates along the plate plane. As also mentioned, the connecting body can be designed in such a way that a force-transmitting connection between the first tread plate and the second tread plate is provided with a movement parallel to the plate plane. However, this also means that the force-transmitting connection between the first tread plate and the second tread plate can be canceled as a result of loads that occur during operation of the vehicle. Because a fixing device is provided in this embodiment, such a movement of the first tread plate and the second tread plate parallel to the plate plane can be avoided. As a result, the force-transmitting connection between the first tread plate and the second tread plate is also prevented from being accidentally undone.

In a further developed embodiment, the fixing device

can comprise a first fixing body attached to the first tread plate and/or a second fixing body attached to the second tread plate, wherein

the first fixing body can be brought into engagement in a form-fit or force-fit to the second tread plate, and/or

the second fixing body can be brought into engagement with the first tread plate in a form-fit or force-fit.

The fixing bodies can, for example, be designed as rotatable hooks that can be rotated with a tool such as a square key. Fixing bodies in the form of locking hooks are also conceivable. In this way, the first tread plate and the second tread plate can be easily connected and separated from each other. A screw connection, a plug connection, or a snap-in connection would also be conceivable.

In a further developed embodiment,

the first end strip and/or the first wagon-end face can have first fastening sections into which second counter-fastening sections of the second locking device can be brought into engagement in a form-fit by means of a movement along the plate plane, and/or

the second end strip and/or the second wagon-end face have second fastening sections into which first counter-fastening sections of the first locking device can be brought into engagement in a form-fit by means of a movement along the plate plane.

The first and second fastening sections as well as the first and second counter-fastening sections can be part of the first locking device or second locking device, which can be easily adapted to the structural conditions of the first vehicle part and the second vehicle part.

According to a further embodiment, the first counter-fastening sections can be rotatably mounted on the primary second base plate, and the second counter-fastening sections can be rotatably mounted on the secondary second base plate.

One embodiment of the invention relates to a vehicle with a first vehicle part and a second vehicle part, wherein the first vehicle part and the second vehicle part can be or are connected to one another in an articulated manner by means of a coupling device, and the vehicle has a gangway according to one of the previous embodiments.

The technical effects and advantages that can be achieved with the proposed vehicle are essentially the same as those discussed for the present gangway. In summary, it should be noted that a force flow can be provided directly between the first wagon-end face and the centering element, depending upon the design also including an end strip, without the force flow passing through base plates or similar structural elements. This makes the vehicle suitable for high loads in the transition, which occur in particular in underground railways and metros.

### BRIEF DESCRIPTION OF THE DRAWINGS

Exemplary embodiments of the invention are explained in more detail below with reference to the accompanying drawings, in which:

FIG. 1 is a side view through a first exemplary embodiment of a gangway that is arranged between a first vehicle part and a second vehicle part of a vehicle, wherein the gangway is in a first rotational position;

FIG. 2A is the first embodiment of the gangway shown in FIG. 1 in a perspectival view also in the first rotational position;

FIG. 2B is the first embodiment of the gangway shown in FIG. 1 in a perspectival view in a second rotational position;

FIG. 3 is a plan view of a second exemplary embodiment of the gangway, which is in the first rotational position;

FIG. 4 is a perspectival view of the second exemplary embodiment of the gangway, wherein the gangway is in the second rotational position;

FIG. 5 is a perspectival view of the second exemplary embodiment of the gangway without the wagon-end face of a vehicle part in the first rotational position;

FIG. 6 is a sectional view approximately along the section plane X-X defined in FIG. 5;

FIG. 7A is an enlarged view of section A defined in FIG. 5;

FIG. 7B is a schematic and enlarged view of part of section B defined in FIG. 7A;

FIG. 8A is a perspectival view of the second exemplary embodiment of the gangway, wherein the gangway is in the first rotational position;

FIG. 8B is an enlarged view of section D defined in FIG. 8A;

FIG. 8C is an enlarged view of section E defined in FIG. 8A;

FIG. 9A is an enlarged view of section C defined in FIG. 7A from a different perspective to that of FIG. 7A;

FIG. 9B is a bottom view of the section of the gangway shown in FIG. 9A;

FIG. 10 is a sectional view through the gangway approximately along the section plane Y-Y defined in FIG. 5;

FIG. 11 is an enlarged view of section F defined in FIG. 10;

FIG. 12 is an enlarged view of the section G defined in FIG. 4 in a first embodiment; and

FIG. 13 is an enlarged view of the section G defined in FIG. 4 in a second embodiment not shown in FIG. 4.

### DETAILED DESCRIPTION OF THE INVENTION

FIG. 1 shows a first embodiment of a gangway 101 according to the present invention in a side view. The gangway 101 provides a transition between a first vehicle part 12 and a second vehicle part 14 of a vehicle 16 - for example, an underground train, a metro, or an articulated bus. The first vehicle part 12 and the second vehicle part 14 are only shown in principle. The first vehicle part 12 and the second vehicle part 14 are connected to one another in an articulated and detachable manner by means of a coupling device 18. The first vehicle part 12 forms a first wagon-end face 20, and the second vehicle part 14 forms a second wagon-end face 22. In addition, a plate plane PE is defined in FIG. 1, which will be discussed in more detail later.

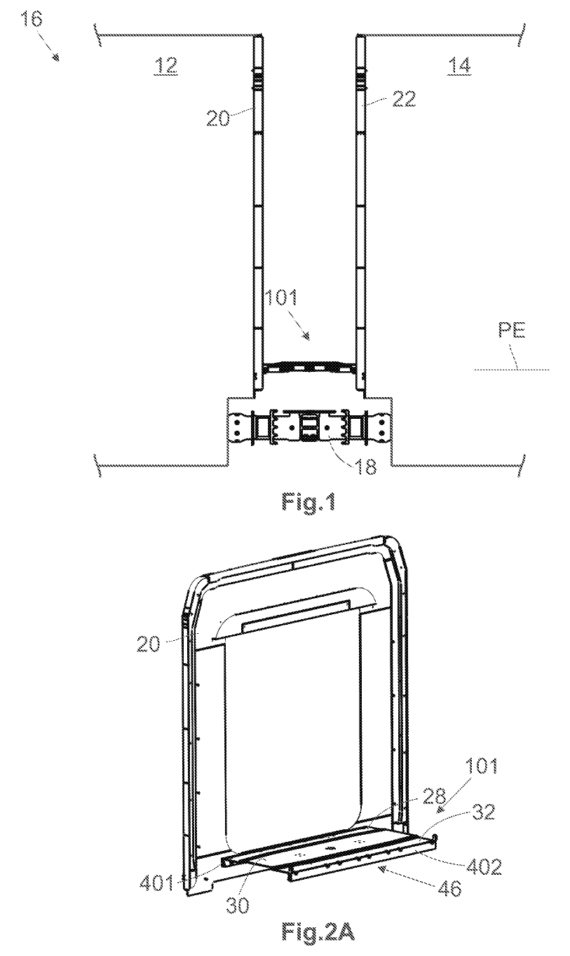

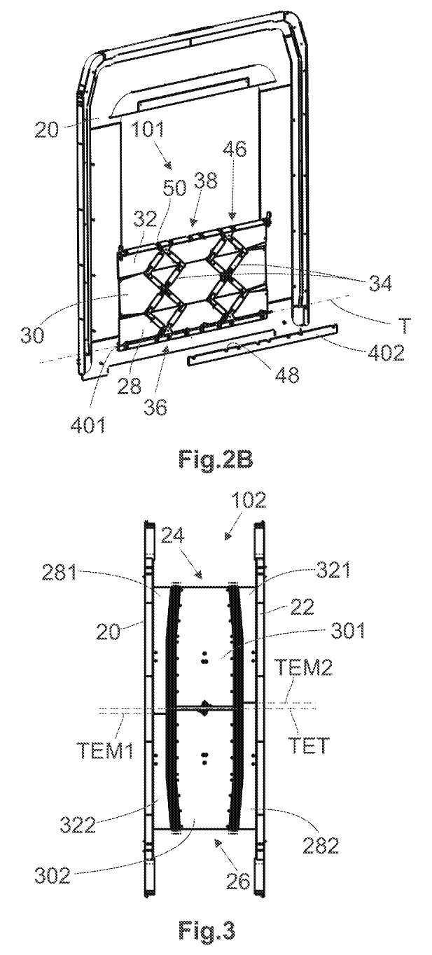

FIG. 2A and 2B show the gangway 101 shown in FIG. 1 using perspectival views in a first rotational position and in a second rotational position, respectively. For reasons of clarity, in comparison to FIG. 1, the second wagon-end face 22 in particular is not shown.

As can be seen from FIG. 2B, the gangway 101 comprises two centering elements 34, each with a first end 36 and a second end 38. The centering element 34 is designed like a scissor frame. Furthermore, the gangway 101 has a first base plate 28, a second base plate 32, and a tread plate 30, which are movably connected to the centering element 34 in a plate plane PE (see FIG. 1). The first base plate 28 and the second base plate 32 are bent by slightly more than 90° at their free ends facing away from the tread plate 30.

In addition, the gangway 101 is provided with a rotation axis T fastened to the first wagon-end face 20 or interacting with the first wagon-end face 20 and running within the plate plane PE or parallel to the plate plane PE, which rotation axis passes through the centering element 34 at the first end 36 for the rotatable connection of the centering element 34 to the first wagon-end face 20. The features “first end” 36 and “second end” 38 can be interpreted broadly, so that, for example, the rotation axis T could also pass through the centering element 34 somewhat further towards the center thereof.

Furthermore, the gangway 101 has a locking device 46 with which the centering element 34 at its second end 38 and/or the second base plate 32 can be detachably connected to the second wagon-end face 22 (see FIG. 1).

A first end strip 401 is arranged on the first wagon-end face 20, and a second end strip 402 is arranged on the second wagon-end face 22, wherein the rotation axis T is fastened to the first end strip 401. However, the rotation axis T can also be attached directly to the first wagon-end face 20 (not shown). The locking device 46 cooperates with the second end strip to fix the centering element 34 in the rotational position shown in FIG. 2. For this purpose, the second wagon-end face 22 and/or the second end strip 402 have fastening sections 48 into which counter-fastening sections 50 of the second base plate 32 and/or the centering element 34 can be introduced.

A reverse arrangement in which the gangway 101 is rotatably mounted on a rotation axis T which is fastened to the second wagon-end face 22 or to the second end strip 402 is also conceivable. The structure of the gangway described above also applies in an analogous form to the reverse arrangement.

FIG. 3 shows a second embodiment of the gangway 102 in a plan view. It can be seen that the gangway 102 according to the second embodiment has a first subunit 24 and a second subunit 26 which extends between the first wagon-end face 20 and the second wagon-end face 22, and accordingly provides the transition between the first vehicle part 12 (not shown here) and the second vehicle part 14 (also not shown). The first subunit 24 comprises a primary first base plate 281, a first tread plate 301, and a primary second base plate 321. Accordingly, the second subunit 26 comprises a secondary first base plate 282, a second tread plate 302, and a secondary second base plate 322. For this purpose, the first subunit 24 and the second subunit 26 are in a first rotational position.

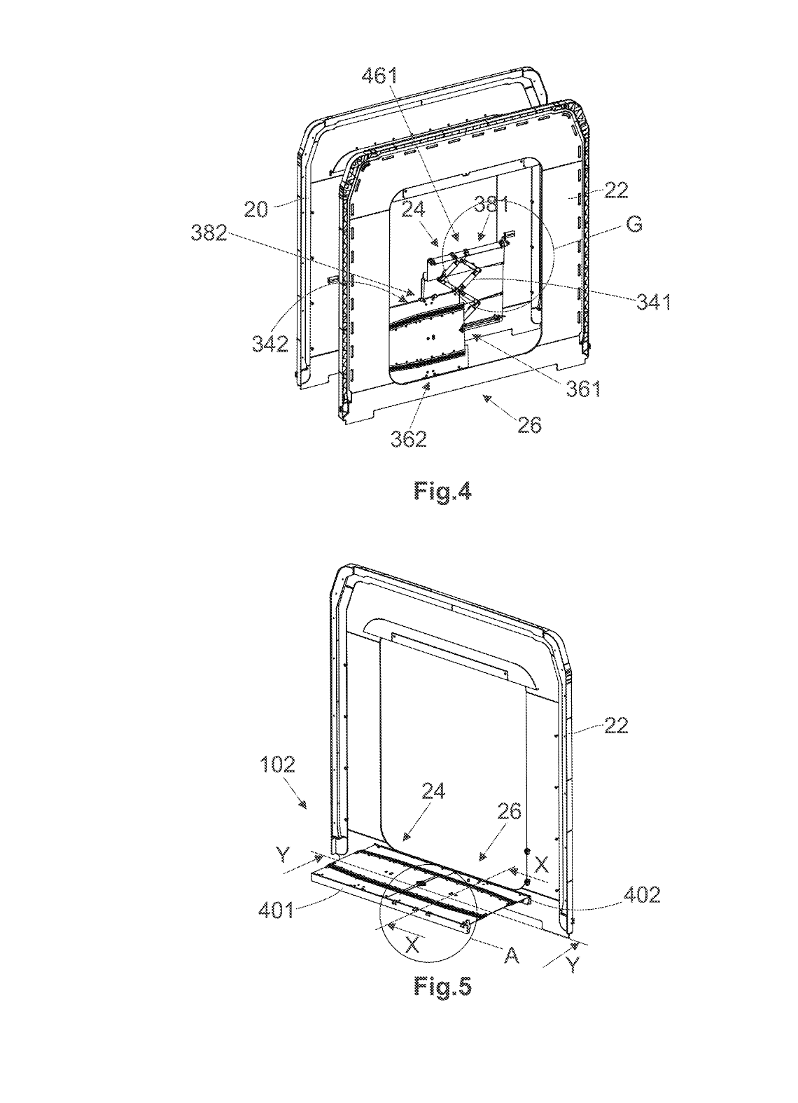

In FIG. 4, the gangway 102 shown in FIG. 1 and 2 is shown in a perspectival view. In FIG. 4, however, the first subunit 24 and the second subunit 26 are in a second rotational position in which the first subunit 24 and the second subunit 26 are rotated by approximately 90° relative to the first rotational position. FIG. 4 clearly shows that the first subunit 24 is rotatably attached to the first wagon-end face 20, and the second subunit 26 is rotatably attached to the second wagon-end face 22, so that a high degree of symmetry of the gangway 102 is achieved, whereby the first subunit 24 and the second subunit 26 can be constructed largely identically. However, it is also possible to mount both the first subunit 24 as well as the second subunit 26 on a common rotation axis, viz., either on the first rotation axis T1 or on the second rotation axis T2.

It can be seen that the first subunit 24 further has a first centering element 341 with which the primary first base plate 281, the first tread plate 301, and the primary second base plate 321 (cf. FIG. 3) are movably connected along the plate plane PE defined in FIG. 1. The first centering element 341 forms a primary first end 361, hidden in FIG. 4, and a primary second end.

The plate plane PE is substantially defined by the maximum extension of the base plates 281, 282, 321, 322 and the tread plates 301, 302, so that the plate plane PE follows the rotation between the first rotational position and the second rotational position. With respect to the second rotational position in FIG. 4, the first subunit 24 and the second subunit 26 can be moved substantially parallel to the first wagon-end face 20 and the second wagon-end face 22 - in other words, up and down, but also sideways.

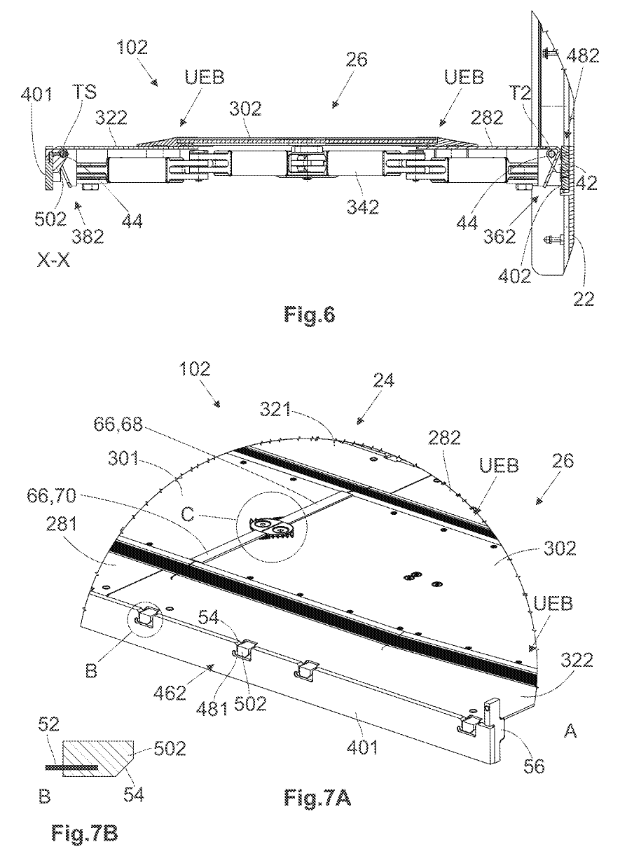

The first subunit 24 is constructed identically to the second subunit 26. Therefore, the second subunit 26 has a second centering element 342 which is hidden in FIG. 3 and accordingly not visible (see FIG. 6, however). The second centering element 342 forms a secondary first end 362 and a secondary second end 382.

FIG. 5 shows a perspectival view of the gangway 102 without the first wagon-end face 20. A first end strip 401 can be seen which is or can be fastened to the first wagon-end face 20 with fastening means (not shown), such as screws or the like. Correspondingly, the gangway 102 comprises a second end strip 402 which is fastened to the second wagon-end face 22.

FIG. 6 shows the gangway 102 in a sectional view approximately along the section plane X-X defined in FIG. 5. The section plane X-X runs through the second subunit 26, and in such a way that the second centering element 342 is visible. The second end strip 402 forms a plurality of receiving projections 42, each with a through-hole 44 through which a second rotation axis T2 extends, wherein the second rotation axis T2 is formed by a bolt or the like. The second centering element 342 is rotatably connected at its secondary first end 362 to the second rotation axis T2, about which the second subunit 26 between the first rotational position and the second rotational position can rotate about the second rotation axis T2, as can be seen, among other things, from a comparison of FIG. 2 and 3.

The first end strip 401 also forms corresponding receiving projections 42 and corresponding through-holes 44 through which a first rotation axis T1 runs. The first centering element 341 is connected at its primary first end 361 to the first rotation axis T1 so as to be rotatable thereto (not visible in FIG. 6 due to the course of the section plane X-X). The first subunit 24 is also rotatable between the first rotational position and the second rotational position about the first rotational axis T1, which can also be derived from a comparison of FIG. 2 and 3.

FIG. 7A shows section A defined in FIG. 5 in an enlarged form. The gangway 102 has a second locking device 462 with which the secondary second base plate 322 can be connected to the first end strip 401. For this purpose, the first end strip 401 is provided with first fastening sections 481, into which hook-shaped second counter-fastening sections 502 of the second locking device 462 can be brought into engagement in a form-fit by means of a movement along the plate plane PE. The first fastening sections 481 have an approximately L-shaped cross-section. FIG. 7B is a schematic and not-to-scale, enlarged sectional view through a second counter-fastening section 502 shown in FIG. 7A as section B. It can be seen that the second counter-fastening section 502 has a pin 52 which protrudes laterally therefrom. To connect the secondary second base plate 322 to the first end strip 401, the second subunit 26 is first moved from the second rotational position to the first rotational position, wherein the second subunit 26 is moved with respect to the plate plane PE such that the pin 52 can be introduced into the first fastening section 481. To facilitate insertion, the first fastening sections 481 and the second counter-fastening sections 502 each have insertion bevels 54.

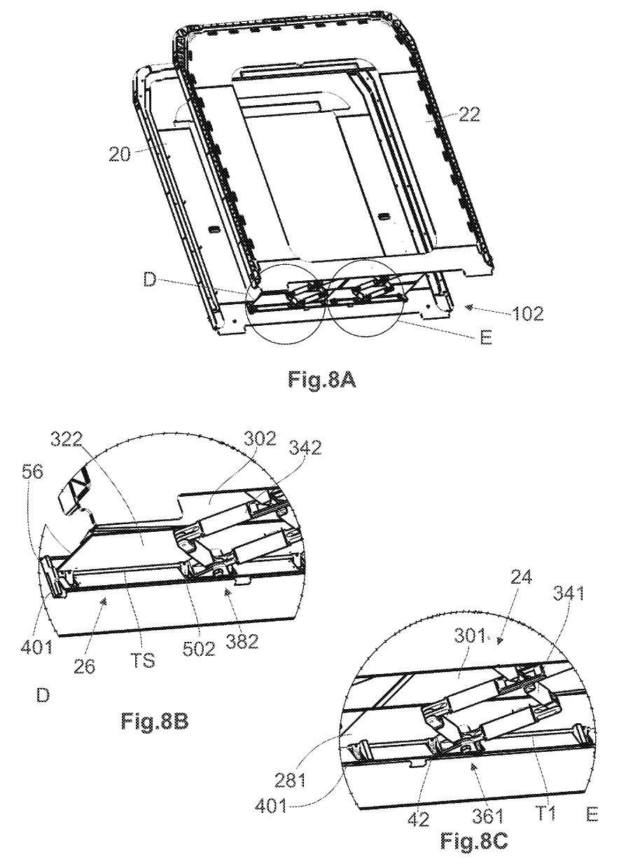

In FIG. 8A, the gangway 102 shown in FIG. 1 and 2 is shown in a perspectival view so that the gangway 102 is visible from below. In FIG. 8A, the first subunit 24 and the second subunit 26 are in the first rotational position. FIG. 8B shows the section D defined in FIG. 8A in an enlarged view that shows the second subunit 26. It can be seen that the second counter-fastening sections 502 are rotatably mounted on the secondary second base plate 322 by means of a bearing axis TS. The second counter-fastening sections 502 themselves are connected for conjoint rotation with the bearing axis TS. The bearing axis TS also runs through the second centering element 342 at its secondary second end 382.

When the second subunit 26 is moved into the second rotational position, the bearing axis TS is also rotated about the second rotational axis T2 (see also FIG. 6). The first subunit 24 is correspondingly constructed (not shown).

In the first rotational position, the second counter-fastening sections 502 come to rest on the base of the first fastening sections 481, thereby establishing the first rotational position (see in particular FIG. 7A). As mentioned, the first end strip 401 is attached to the first wagon-end face 20 of the first vehicle part 12. During operation, the rotational position of the first end strip 401 relative to the second base plate 322 can change, in particular as a result of pitching movements. As a result, the rotational position of the second counter-fastening sections 502 in the first fastening sections 481 would also change. As can be seen from FIG. 7A and 8B, an alignment element 56 is arranged on the secondary second base plate 322 and comes into contact with the first end strip 401 in the first rotational position of the second subunit 26. In particular, in FIG. 8B, it can be seen that the alignment element 56 is connected for conjoint rotation with the bearing axis TS. Due to the contact of the alignment element 56 on the first end strip 401, the alignment element 56 follows the changes in the rotational position of the first end strip 401 relative to the second base plate 322. These changes are transmitted from the alignment element 56 to the first rotation axis T1, and from there to the second counter-fastening sections 502. As a result, the second counter-fastening sections 502 also follow these relative movements, so that the rotational position of the second counter-fastening sections 502 in the first fastening sections 481 does not change.

FIG. 8C shows the section E defined in FIG. 8A in an enlarged view. Clearly visible is the first rotation axis T1, with which the first centering element 341 is rotatably connected in the region of its primary first end 361 to the first wagon-end face 20. The first rotation axis T1 is fastened to the first wagon-end face 20 or to the first end strip 401 by means of a receiving projection 42.

After the second counter-fastening sections 502 have been inserted into the first fastening sections 481, the second subunit 26 is moved slightly along the plate plane PE. As a result of this movement, the pin 52 is introduced into the closed section of the first fastening section 481 on the left in FIG. 7A, so that an undercut and consequently a form-fit with respect to a rotational movement into the second rotational position is brought about. The second subunit 26 is therefore fixed in the first rotational position.

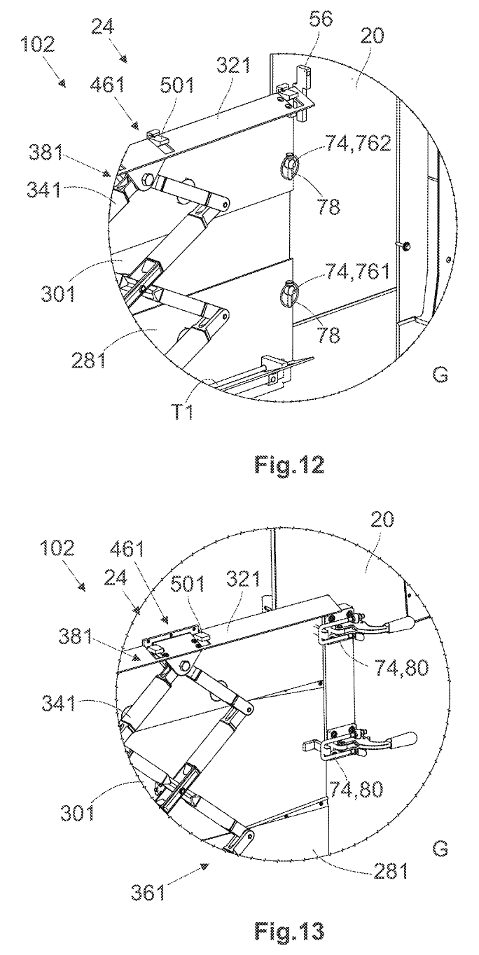

As mentioned, the first subunit 24 is structurally identical or at least largely identical to the second subunit 26. The first end strip 401 is also identical to the second end strip 402. Therefore, the gangway 102 comprises a first locking device 461 with which the primary second base plate 321 can be connected to the second end strip 402. The second end strip 402 has second fastening sections 482, into which first counter-fastening sections 501 of the first locking device 461 can be introduced in the described manner in order to fix the first subunit 24 in the first rotational position (see, for example, FIG. 11 and 12).

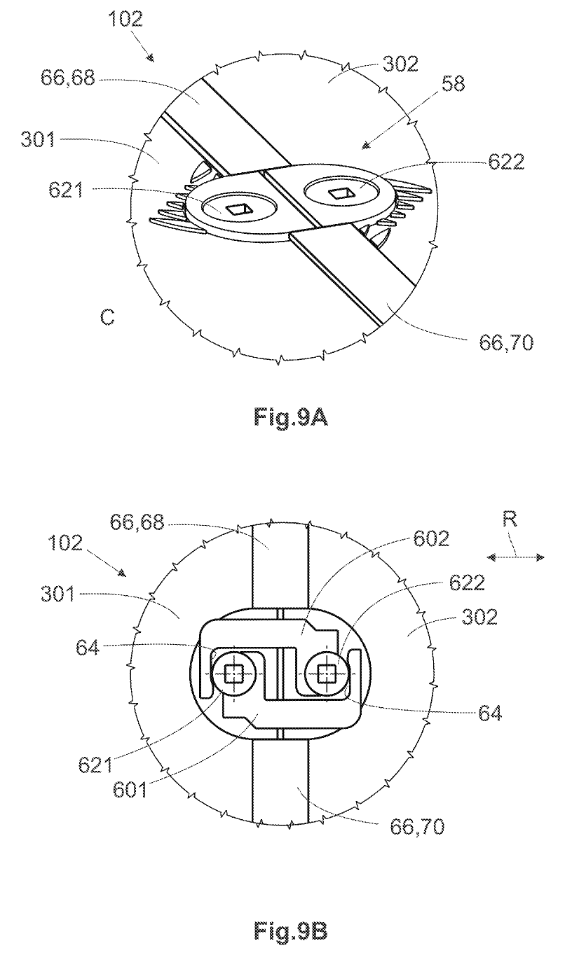

FIG. 9A shows the section C defined in FIG. 7A enlarged and from a slightly different perspective, and FIG. 9B shows the section C from a bottom view. FIG. 7 and 8 show a fixing device 58 with which the first tread plate 301 and the second tread plate 302 can be detachably connected to one another when they are in the first rotational position. The fixing device 58 comprises a first fixing body 601 and a second fixing body 602 which are each mounted in the first tread plate 301 and in the second tread plate 302 so as to be rotatable about a first fixing body axis 621 and a second fixing body axis 622, respectively, and can be rotated, for example, with a square key. From FIG. 9, it can be seen that the first fixing body 601 and the second fixing body 602 are each hook-shaped. In FIG. 9B, the fixing device 58 is in the closed state. The first fixing body 601 encompasses the second fixing body axis 622 of the second fixing body 602. Correspondingly, the second fixing body 602 encompasses the first fixing body axis 621 of the first fixing body 601. The first fixing body 601 and the second fixing body 602 have fixing sections 64 which approximate the shape of the first fixing body axis 621 and the second fixing body axis 622 in order to produce a minimal form-fit in the closed state. In the closed state, a movement of the first tread plate 301 and the second tread plate 302 along the plate plane PE is thereby avoided. In particular, the first tread plate 301 and the second tread plate 302 cannot be moved along the direction indicated by the arrow R. This prevents the above-mentioned undercut of the pin 52 from being eliminated, and the first subunit 24 and the second subunit 26 from leaving the first rotational position.

To release the fixing device 58, the first fixing body axis 621 and the second fixing body axis 622 can be rotated, for example, by means of a square key.

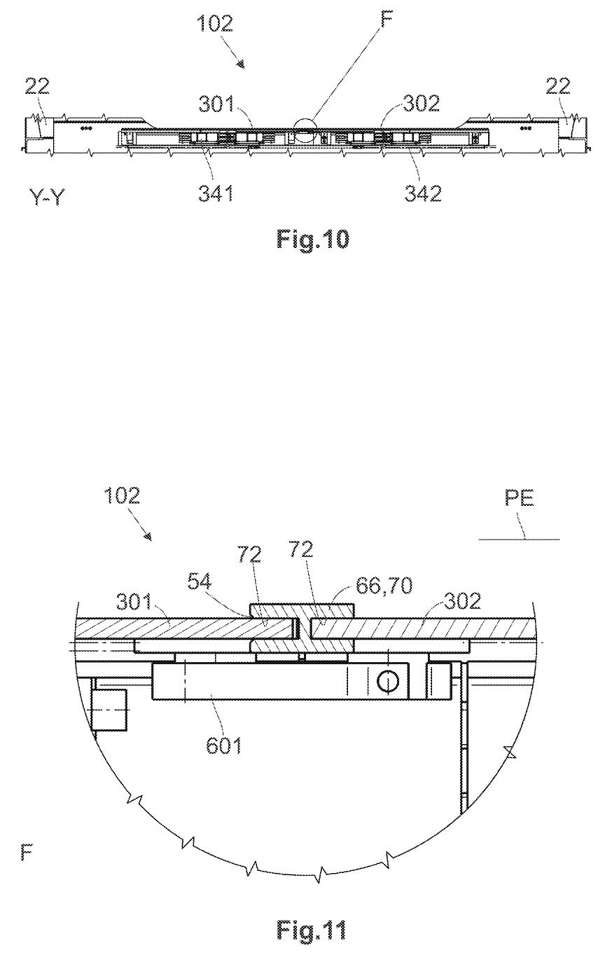

FIG. 10 shows a sectional view through the gangway 102 approximately along the section plane Y-Y defined in FIG. 5. FIG. 11 shows the section D defined in FIG. 10 in enlarged form. A connecting body 66 can be seen which is divided into a first subsection 68 connected to the first tread plate 301 and a second subsection 70 connected to the second tread plate 302 (see also FIG. 7A, 8, and 9). Due to the selected section plane, the second subsection 70 can be seen in FIG. 10 and 11, which is, however, identical in construction to the first subsection 68. The second subsection 70 has an H-shaped cross-section and consequently two recesses 72. The second subsection 70 is connected to the second tread plate 302 via one of the recesses 72, wherein the second tread plate 302 rests against the bottom of the recess 72. The first tread plate 301 can be introduced into the opposite recess 72 of the second subsection 70 with the movement described above along the plate plane PE. To facilitate insertion, the second subsection 70 has insertion bevels 54. In the inserted state, a gap remains between the bottom of the relevant recess 72 and the first tread plate 301 - for example, in order to be able to compensate for expansions due to temperature increases or tolerance deviations. With the connecting body 66, the first tread plate 301 and the second tread plate 302 can be detachably connected to each other. If, for example, the first tread plate 301 is loaded, this load is at least partially transferred to the second tread plate 302, whereby the gangway 102 is loaded more evenly overall. Not shown is an embodiment in which, additionally or alternatively, the base plates 281, 282, 321, 322 can be connected to the connecting body 66 in the described way.

The following also contributes to the even distribution of loads within the gangway 102: As can be seen in particular from FIG. 3, the first subunit 24 and the second subunit 26 do not abut each other along a single parting plane. Rather, the first tread plate 301 and the second tread plate 302 abut one another at a tread plate parting plane TET, the primary first base plate 281 and the secondary second base plate 322 abut one another at a first base plate parting plane TEM1, and the secondary first base plate 282 and the primary second base plate 321 abut one another at a second base plate parting plane TEM2, wherein a gap can remain in each case for the mentioned reasons. The tread plate parting plane TET, the first base plate parting plane TEM1, and the second base plate parting plane TEM2 run parallel and offset from each other.

As can be seen in particular from FIG. 6 and 7A, the first tread plate 301 and the second tread plate 302 are arranged on the base plates 281, 282, 321, 322 and form an overlapping region UEB. For example, when the first tread plate 301 is loaded, the offset arrangement of the tread plate parting plane TET, the first base plate parting plane TEM1, and the second base plate parting plane TEM2 causes this load to be transferred not only to the primary first base plate 281 and the primary second base plate 321, but also to the secondary second base plate 322. This also contributes to ensuring that the gangway 102 is more evenly loaded.

FIG. 12 and 13 each show an enlarged representation approximating the section E defined in FIG. 4 in a first embodiment or a second embodiment. In both figures, the first subunit 24 is in the second rotational position. In order to be able to fix the first subunit 24 in the second rotational position, the gangway 102 is equipped with holding means 74. In the embodiment shown in FIG. 12, these comprise a first pin 761 and a second pin 762 which are arranged on the first wagon-end face 20 and protrude therefrom. The first pin 761 can be inserted into an eye of the primary first base plate 281, and the second pin 762 into an eye of the primary second base plate 321. For securing, a cotter pin 78 is inserted into the first pin 761 and the second pin 762, whereby the first subunit 24 is held on the first wagon-end face 20 and consequently in the second rotational position. The use of a single pin and a single eye, which could also be arranged in the first tread plate 301, is also conceivable.

The holding means according to the embodiment shown in FIG. 13 has two lever locks which cooperate with corresponding locking hooks 80 arranged on the secondary first base plate 282 and the first tread plate 301 in order to hold the first subunit 24 in the second rotational position. Correspondingly, the second subunit 26 can be connected to the second wagon-end face 22 in the second rotational position (not shown).

### LIST OF REFERENCE SIGNS

101, 102 Gangway

12 First vehicle part

14 Second vehicle part

16 Vehicle

18 Coupling device

20 First wagon-end face

22 Second wagon-end face

24 First subunit

26 Second subunit

28, 281, 282 First base plate

30, 301, 302 Tread plate

32, 321, 322 Second base plate

34, 341, 342 Centering element

36, 361, 362 First end

38, 381, 382 Second end

40, 401, 402 End strip

42 Receiving projection

44 Through-hole

46, 461, 462 Locking device

48, 481, 482 Fastening section

50, 501, 502 Counter-fastening section

52 Pin

54 Insertion bevel

56 Alignment element

58 Fixing device

601, 602 Fixing body

621, 622 Fixing body axis

64 Fixing section

66 Connecting body

68 First subsection

70 Second subsection

72 Recess

74 Holding means

76 Pin

78 Cotter pin

80 Locking hooks

PE Plate plane

R Arrow

T, T1, T2 Rotation axis

TS Bearing axis

TEM Base plate parting plane

TET Tread plate parting plane

UEB Overlapping region

1. A gangway for providing a transition between a first vehicle part and a second vehicle part of a vehicle, wherein the first vehicle part has a first wagon-end face, and the second vehicle part has a second wagon-end face, comprising:
at least one centering element having a first end and a second end;
at least one first base plate, at least one second base plate, and at least one tread plate which are movably connected to the centering element in a plate plane; and
a rotation axis attached to the first wagon-end face or cooperating with the first wagon-end face and running within the plate plane or parallel to the plate plane;
wherein, for rotatably connecting the centering element to the first wagon-end face, the rotation axis passes through the centering element at the first end of the centering element.

2. The gangway according to claim 1, wherein the gangway has a locking device with which the centering element at its second end and/or the second base plate is detachably connected to the second wagon-end face.

3. The gangway according to claim 1, further comprising:
a first end strip arranged on the first wagon-end face; and/or
a second end strip arranged on the second wagon-end face;
wherein the first rotation axis is attached to the first end strip, and/or the locking device cooperates with the second end strip for releasably attaching the centering element.

4. The gangway according to claim 3, wherein the second wagon-end face and/or the second end strip have fastening sections into which counter-fastening sections of the second base plate and/or the centering element are introduced.

5. The gangway according to claim 4, wherein the counter-fastening sections are rotatably mounted on the gangway.

6. The gangway according to claim 1, wherein the centering element is movable between:
a first rotational position in which the centering element and/or the second base plate are connected to the second wagon-end face; and
a second rotational position;
further comprising a holding means for fixing the centering element in the second rotational position, the holding means being arranged on the first wagon-end face.

7. The gangway according to claim 1, wherein:
the at least one centering element comprises a first centering element and a second centering element, the first end of the first centering element being a primary first end and the second end of the first centering element being a primary second end, the first end of the second centering element being a secondary first end and the second end of the second centering element being a secondary second end; and/or
the at least one first base plate comprises a primary first base plate, the at least one second base plate comprises a primary second base plate, and the at least one tread plate comprises a first tread plate, the primary first base plate, primary second base plate, and first tread plate being movably connected to the first centering element in the plate plane; and/or
the at least one first base plate comprises a secondary first base plate, the at least one second base plate comprises a secondary second base plate, and the at least one tread plate comprises a second tread plate, the secondary first base plate, secondary second base plate, and second tread plate being connected to the second centering element in the plate plane; and/or
the rotation axis comprises a first rotation axis which is fastened to the first wagon-end face or second wagon-end face and runs within the plate plane or parallel to the plate plane and which passes through the first centering element at the primary first end or at the primary second end in order to connect the first centering element to the first wagon-end face or to the second wagon-end face; and/or
the rotation axis comprises a second rotation axis which is fastened to the first wagon-end face or second wagon-end face and runs within the plate plane or parallel to the plate plane and which passes through the second centering element at the secondary first end or at the primary second end in order to connect the second centering element to the first wagon-end face or to the second wagon-end face.

8. The gangway according to claim 7, further comprising:
a first locking device with which the first centering element at its primary second end or the primary second base plate is connected to the first wagon-end face or the second wagon-end face; and/or
a second locking device with which the second centering element at its secondary second end or the secondary second base plate is connected to the first wagon-end face or the second wagon-end face.

9. The gangway according to claim 7, further comprising:
a connecting body with which the first tread plate and the second tread plate are connected to one another in a force-transmitting and detachable manner.

10. The gangway according to claim 9, wherein the connecting body has projections and/or recesses with which the first tread plate and the second tread plate are brought into engagement in a form-fit by means of a movement along the plate plane.

11. The gangway according to claim 9, wherein the connecting body comprises:
a first subsection connected to the first tread plate; and
a second subsection connected to the second tread plate.

12. The gangway according to claim 7, further comprising a fixing device with which the first tread plate and the second tread plate are detachably connected to one another in such a way that a position of the first tread plate is fixed relative to the second tread plate.

13. The gangway according to claim 12, wherein the fixing device comprises:
a first fixing body attached to the first tread plate and/or a second fixing body attached to the second tread plate;
wherein
the first fixing body is brought into engagement in a form-fit or force-fit with the second tread plate; and/or
the second fixing body is brought into engagement in a form-fit or force-fit with the first tread plate.

14. The gangway according to claim 8, further comprising:
a first end strip arranged on the first wagon-end face; and/or
a second end strip arranged on the second wagon-end face;
wherein:
the first end strip and/or the first wagon-end face have first fastening sections into which second counter-fastening sections of the second locking device are brought into engagement in a form-fit by means of a movement along the plate plane; and/or
the second end strip and/or the second wagon-end face have second fastening sections into which first counter-fastening sections of the first locking device are brought into engagement in a form-fit by means of a movement along the plate plane.

15. A vehicle, comprising:
a first vehicle part and a second vehicle part, wherein the first vehicle part and the second vehicle part are connected to one another in an articulated manner by a coupling device; and
a gangway according to claim 1.
